(19) United States
(12) Patent Application Publication
(10) Pub. No.: US 2026/0242267 A1
(43) Pub. Date: Aug. 20, 2026

(54) WATER PURIFICATION SYSTEM

(71) Applicant: ZRO Waste Water, Inc., Casper, WY (US)

(72) Inventors: David BEEMAN, Somis, CA (US); Douglas HORN, Louisville, KY (US); Stephen KING, Louisville, KY (US); Kevin GILLESPIE, Chatsworth, CA (US); Richard William BEEMAN, Chesapeake, VA (US)

(21) Appl. No.: 19/053,979

(22) Filed: Feb. 14, 2025

(51) Int. Cl. C02F 9/20; B01D 61/02; B01D 61/04; B01D 61/12; C02F 1/00; C02F 1/28; C02F 1/42; C02F 1/44; C02F 101/32; C02F 101/36

(52) U.S. Cl. CPC C02F 9/20; B01D 61/025; B01D 61/04; B01D 61/12; C02F 1/008; B01D 2313/18; B01D 2313/243; C02F 1/283; C02F 1/42; C02F 2001/422; C02F 1/441; C02F 2101/322; C02F 2101/36; C02F 2101/40; C02F 2201/005; C02F 2209/03; C02F 2209/42; C02F 2301/043; C02F 2301/046; C02F 2303/02; C02F 2303/22

(57) ABSTRACT

A water purification and treatment system is disclosed, featuring a reverse osmosis system and a water formulation system. A water inlet supplies water to the water purification and treatment system. The reverse osmosis system produces permeate water and concentrate water. A recirculation pipe returns the concentrate water to the reverse osmosis system. The water formulation system receives the permeate water into a storage tank with a level sensor, a static inline mixer, and two water formulation supplies for treating the permeate water. The treated water can then be delivered to a user through a water outlet. A bypass with a valve can directly connect the water inlet to the water outlet. A controller manages the reverse osmosis feed pump, level sensor, water formulation supplies, and bypass valve to monitor water levels, control pump operation, activate the bypass valve when needed, and adjust water formulation for desired water quality.

### TECHNICAL FIELD

Aspects of this document relate generally to a water purification and treatment system.

### BACKGROUND

Various water purification and treatment systems have been developed to address the need for clean and safe drinking water. Conventional water purification systems typically involve multiple stages of filtration and treatment processes to remove impurities and contaminants from the water. One common method used in water treatment systems is reverse osmosis, which utilizes a semipermeable membrane to separate contaminants from water molecules based on their size and charge. The reverse osmosis process involves forcing water through the membrane under pressure, allowing only pure water molecules to pass through while retaining impurities.

In traditional reverse osmosis systems, a feed pump is employed to pressurize the water and facilitate its passage through the reverse osmosis membrane. The concentrate water containing the rejected impurities is then frequently disposed of directly into a sewer line or stored for use in an application that does not require potable water.

Additionally, water formulation systems are often integrated into water treatment systems to further enhance the quality of the purified water. These systems typically involve the addition of specific formulations or chemicals to the water to adjust its pH level, mineral content, or other properties to meet desired standards or user preferences. However, despite advancements in water purification technologies, existing systems still face challenges in achieving comprehensive water treatment solutions that effectively combine and automate purification, formulation, and control functionalities. None of these approaches have provided a comprehensive solution that combines the features described in this disclosure.

### SUMMARY

Aspects of this document relate to a water purification and treatment system comprising a water inlet configured to receive water from a water source, a reverse osmosis system fluidly coupled to the water inlet and configured to purify the water passing through the reverse osmosis system, the reverse osmosis system having a reverse osmosis membrane configured to produce permeate water which passes through the reverse osmosis membrane and concentrate water which recirculates back through the reverse osmosis system, a reverse osmosis feed pump configured to pump water from the water inlet to the reverse osmosis membrane, and a recirculation pipe configured to pass the concentrate water from the reverse osmosis membrane back through the reverse osmosis system, a water formulation system fluidly coupled to the reverse osmosis system and configured to receive the permeate water from the reverse osmosis system, the water formulation system having a storage tank configured to store the permeate water, the storage tank comprising a level sensor configured to measure a level of water within the storage tank, a static inline mixer configured to maintain movement of the water within the storage tank, a first water formulation supply configured to supply a first formulate to the storage tank to treat the water, the first water formulation supply having a first formulation inlet into the storage tank, and a second water formulation supply configured to supply a second formulate to the storage tank to treat the water, the second water formulation supply having a second formulation inlet into the storage tank positioned on an opposite side of the storage tank from the first formulation inlet, a water outlet fluidly coupled to the water formulation system and configured to supply water to a user, a bypass having a bypass valve configured to selectively couple the water inlet directly to the water outlet, and a controller operably coupled to the reverse osmosis feed pump, the level sensor, the first water formulation supply, the second water formulation supply, and the bypass valve, wherein the controller is configured to monitor the level of water within the storage tank through the level sensor, turn on the reverse osmosis feed pump when the level of water in the storage tank is lower than a refill threshold level, turn off the reverse osmosis feed pump when the level of water in the storage tank is higher than a full threshold level, automatically open the bypass valve to couple the water inlet directly to the water outlet when the level of water in the storage tank is lower than an empty threshold level, and control the first water formulation supply and the second water formulation supply to achieve a desired formulation of water in the storage tank.

Particular embodiments may comprise one or more of the following features. The desired formulation of water in the storage tank may be adjustable by the user. The level sensor may be an ultrasonic level sensor. The reverse osmosis system may have a filter with an anion resin configured to reduce a level of forever chemicals present in the water. The water purification and treatment system may be configured to be shipped as a single ready-to-install unit. The controller may be configured to provide self-diagnostics to the water purification and treatment system. The controller is configured automatically notify a service provider when maintenance or service of the water purification and treatment system is required.

Aspects of this document relate to a water purification and treatment system comprising a water inlet configured to receive water from a water source, a reverse osmosis system fluidly coupled to the water inlet and configured to purify water passing through the reverse osmosis system, a water formulation system fluidly coupled to the reverse osmosis system and configured to receive permeate water from the reverse osmosis system, the water formulation system having a storage tank configured to store the permeate water, the storage tank comprising a level sensor configured to measure a level of water within the storage tank, and a first water formulation supply configured to supply a first formulate to the storage tank to treat the water, the first water formulation supply having a first formulation inlet into the storage tank, a water outlet fluidly coupled to the water formulation system and configured to supply water to a user, a bypass having a bypass valve configured to selectively couple the water inlet directly to the water outlet, and a controller operably coupled to the reverse osmosis system, the level sensor, the first water formulation supply, and the bypass valve, wherein the controller is configured to turn on the reverse osmosis system when the level of water in the storage tank is lower than a refill threshold level, turn off the reverse osmosis system when the level of water in the storage tank is higher than a full threshold level, automatically open the bypass valve to couple the water inlet directly to the water outlet when the level of water in the storage tank is lower than an empty threshold level, and control the first water formulation supply to achieve a desired formulation of water in the storage tank.

Particular embodiments may comprise one or more of the following features. The reverse osmosis system may have a recirculation pipe configured to pass concentrate water produced by the reverse osmosis system back through the reverse osmosis system. The water formulation system may further have a static inline mixer configured to maintain movement of the water within the storage tank. The water formulation system may further have a second water formulation supply configured to supply a second formulate to the storage tank to treat the water. The second water formulation supply may have a second formulation inlet into the storage tank positioned on an opposite side of the storage tank from the first formulation inlet. The reverse osmosis system may have a filter with an anion resin configured to reduce a level of forever chemicals present in the water. The water purification and treatment system may be configured to be shipped as a single ready-to-install unit. The level sensor may be an ultrasonic level sensor.

Aspects of this document relate to a water purification and treatment system comprising a water inlet configured to receive water from a water source, a water formulation system fluidly coupled to a reverse osmosis system and configured to receive permeate water from the water inlet through the reverse osmosis system, the water formulation system having a storage tank configured to store the permeate water, a water outlet fluidly coupled to the water formulation system and configured to supply water to a user, a bypass having a bypass valve configured to selectively couple the water inlet directly to the water outlet, and a controller operably coupled to the bypass valve, wherein the controller is configured to automatically open the bypass valve to couple the water inlet directly to the water outlet when a level of water in the storage tank is lower than an empty threshold level.

Particular embodiments may comprise one or more of the following features. The storage tank may comprise an ultrasonic level sensor configured to measure a level of water within the storage tank. The water formulation system may further have a static inline mixer configured to maintain movement of the water within the storage tank. The water formulation system may further have a first water formulation supply configured to supply a first formulate to the storage tank to treat the water. The first water formulation supply may have a first formulation inlet into the storage tank, wherein the controller is operably coupled to the first water formulation supply and is configured to control the first water formulation supply to achieve a desired formulation of water in the storage tank. The water formulation system may further have a second water formulation supply configured to supply a second formulate to the storage tank to treat the water. The second water formulation supply may have a second formulation inlet into the storage tank positioned on an opposite side of the storage tank from the first formulation inlet. The desired formulation of water in the storage tank may be adjustable by the user. The reverse osmosis system may have a filter with an anion resin configured to reduce a level of forever chemicals present in the water. The water purification and treatment system may be configured to be shipped as a single ready-to-install unit.

The foregoing and other aspects, features, and advantages will be apparent from the specification, drawings, and the claims.

### BRIEF DESCRIPTION OF THE DRAWINGS

Implementations will hereinafter be described in conjunction with the appended drawings, where like designations denote like elements, and:

FIG. 1 illustrates a water purification and treatment system disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word "exemplary," "example," or various forms thereof are used herein to mean serving as an example, instance, or illustration. Any aspect or design described herein as "exemplary" or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The present disclosure is related to a water purification and treatment system 100 that is configured to be installed at, on, or in a building to supply treated water to the building. For example, the water purification and treatment system 100 may be installed at or in an establishment such as a coffee shop. Once installed, the water purification and treatment system 100 is configured to receive water from a water source, such as municipal water, purify and treat the water, and pass the purified and/or treated water to point-of-use sites in the establishment.

Municipal water refers to any water that is delivered to an establishment including, without limitation, well water, lake water processed by a municipality like a town or city, or sea water processed by a municipality like a town or city. An establishment is any residential or commercial facility that is sourced with a municipal water supply. In some embodiments, an establishment using a water purification system disclosed herein is a commercial facility. In some embodiments, an establishment using a water purification system disclosed herein is a residential facility. In some embodiments, an establishment using a water purification system disclosed herein is not a residential facility.

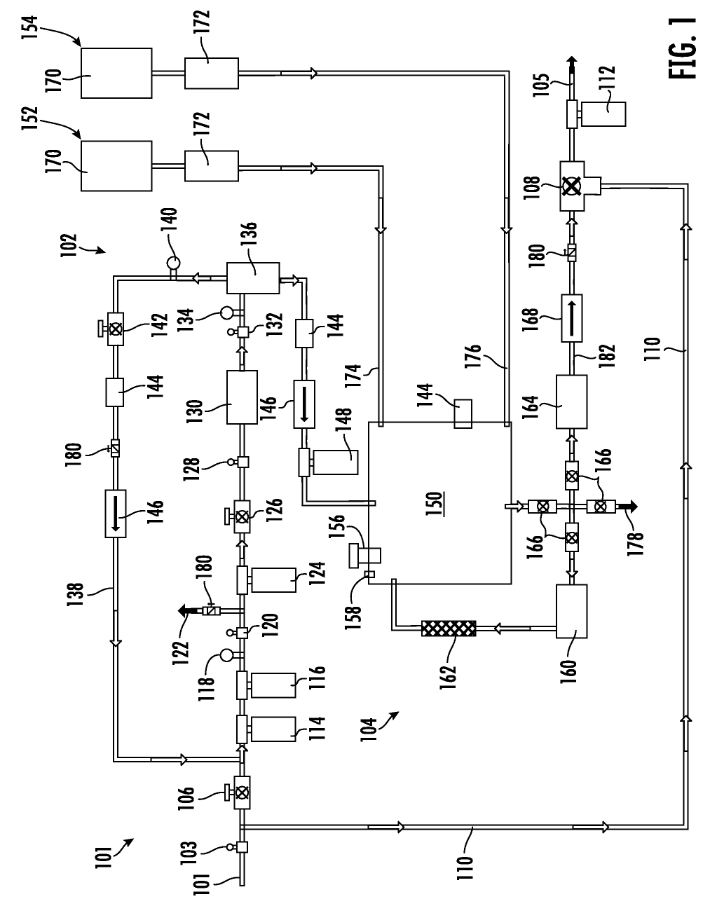

In some embodiments, the water purification and treatment system 100 may have a closed configuration and an open configuration, as shown in the exemplary embodiment illustrated in FIG. 1. Water enters the system 100 through a water inlet 101. The system 100 may comprise a first pressure sensor 103 configured to measure the pressure of the water entering the system 100. The system 100 may have an inlet valve 106 that opens to place the system 100 in the open configuration in which water from the water source passes through the main subsystems of the water purification and treatment system 100 and closes to place the system 100 in the closed configuration in which the water bypasses the main subsystems of the system 100. The system 100 may also have a bypass valve 108 that selects whether water flows through the main subsystems of the system 100, through the bypass 110, or through neither. The inlet valve 106 and the bypass valve 108 may be ball valves. The bypass valve 108 may be a three-way valve. Water exits the system 100 and is delivered to the establishment through a water outlet 105.

In the closed configuration, the water from the water source is diverted from entering the main subsystems of the water purification and treatment system 100, causing the water from the water source to be delivered to the establishment through the water outlet 105 as is. The closed configuration of the water purification and treatment system 100 is useful for allowing inspection, maintenance, and/or repair of one or more subsystems of the system 100 disclosed herein. The closed configuration, also known as the bypass mode, is discussed in more detail below. As shown in FIG. 1, a scale reduction and flavor enhancer (SRE) filter 112 may be positioned to filter the water being delivered to the establishment regardless of whether the water passes through the main subsystems of the water purification and treatment system 100 or bypasses the subsystems of the water purification and treatment system 100 while the system 100 is in the closed configuration. The SRE filter 112 may be positioned after the bypass valve 108 and thus is configured to filter the water even if the water has bypassed the majority of the system 100.

The water purification and treatment system 100 may also comprise a service switch connected after the SRE filter 112. The service switch may be a three-way ball valve and allows for depressurization of the entire system to enable ease of service to all components. The service switch is configured to allow a service technician to engage a switch mounted on the system that would deliver untreated city water around the entire system to allow the service technician to quickly and easily replace or repair components without extensive knowledge of the system without requiring isolation of separate components. In some embodiments, the service switch may be positioned in a different location and may only bypass the high pressure side of the system and allow filtered water to remain in a delivery position.

When the water purification and treatment system 100 is in the open configuration, with the inlet valve 106 in the open position, water from the water source passes through the main subsystems of the water purification and treatment system 100. The open configuration of the water purification and treatment system 100 is useful for purifying and treating the water. Water pressure typical of water delivered to an establishment by a municipality is sufficient to enable the flow of water into the water purification and treatment system 100. For example, water pressure sufficient to enable the flow of water into the water purification and treatment system 100 may be, e.g., about 20 psi to about 60 psi, about 25 psi to about 60 psi, about 30 psi to about 60 psi, about 35 psi to about 60 psi, about 40 psi to about 60 psi, about 45 psi to about 60 psi, or about 50 psi to about 60 psi.

The water purification and treatment system 100 generally comprises two phases: purification and treatment. For example, the water purification and treatment system 100 may comprise a reverse osmosis phase and a water formulation phase. Each of these phases may have a dedicated subsystem within the water purification and treatment system 100. Thus, the water purification and treatment system 100 may comprise a reverse osmosis system 102 and a water formulation system 104. In some embodiments, the reverse osmosis system 102 comprises a granular activated carbon (GAC) filter 114, an SRE filter 116, a first pressure gauge 118, a second pressure sensor 120, a hot water outlet 122, a five-micron filter 124, a valve 126, a third pressure sensor 128, a reverse osmosis feed pump 130, a fourth pressure sensor 132, a second pressure gauge 134, a reverse osmosis membrane 136, and/or a recirculation pipe 138. These components are illustrated in FIG. 1. However, this embodiment is not meant to be limiting, and other embodiments may include different combinations of these components, and additional components could be added to the reverse osmosis system 102 without departing from the scope of this disclosure.

As used herein, a pressure gauge is a mechanical instrument configured to measure pressure and a pressure sensor is a digital instrument configured to measure pressure. The pressure sensors and pressure gauges located throughout the reverse osmosis system 102 provide information regarding the water pressure at different points within the reverse osmosis system 102. In particular, the pressure sensors 103, 120, 128, and 132 may each be wired or wirelessly connected to a controller that allows the user to monitor the reverse osmosis system 102 remotely without needing to physically look at the system 102. Many problems and issues can be identified and/or diagnosed by knowing pressure differentials across different components of the reverse osmosis system 102. For example, the user can determine that the reverse osmosis feed pump 130 is not working if the difference between the pressures read by the third pressure sensor 128 and the fourth pressure sensor 132 are too close together in value.

As shown in FIG. 1, the reverse osmosis system 102 is fluidly coupled to the water inlet 101, with the inlet valve 106 positioned between the water inlet 101 and the reverse osmosis system 102. The reverse osmosis system 102 is configured to purify the water passing through the reverse osmosis system 102. For embodiments of the system 102 with a GAC filter 114, the GAC filter 114 is configured to remove a variety of contaminants from the water, such as taste- and odor-producing compounds, natural organic matter, volatile organic compounds (VOCs), synthetic organic compounds, and disinfection byproduct precursors. This occurs through physical adsorption of the contaminants by the granular activated carbon in the GAC filter 114. For embodiments of the system 102 with an SRE filter 116, the SRE filter 116 is configured to reduce scale by filtering out particles that act as nucleation sites for scale formation. The GAC filter 114 and the SRE filter 116 may be positioned before the hot water outlet 122 to filter the water to a sufficient extent before the water is used for hot water use.

The GAC filter 114 and/or the SRE filter 116 may also comprise a specialized resin configured to reduce and/or remove perfluorooctane sulfonate (PFOS), per- and polyfluoroalkyl substances (PFAS), and other persistent organic pollutants commonly referred to as “forever chemicals.” In some embodiments, the GAC filter 114 or the SRE filter 116 shown in FIG. 1 may be separated into multiple filters 114 with different filtration mediums, such as GAC in a first filter 114 and the specialized resin in a second filter 114. The resin may be an anion resin and may be a synthetic polymer functionalized with quaternary ammonium groups, which provides high anion exchange capacity (AEC) and chemical stability. The resin may be configured to exhibit high selectivity and affinity for the negatively charged fluorinated compounds present in water, including PFOS and PFAS. The pore size and matrix structure of the resin may be configured to allow for effective adsorption and exchange of these contaminants, thus enabling robust performance in both high- and low-concentration scenarios. Thus, when the water flows through the resin bed, the targeted contaminants, including PFOS and PFAS, are selectively adsorbed. The resin’s functional groups exchange ions with the contaminants, effectively binding them to the resin matrix. In some embodiments, the resin is configured for easy regeneration, such as through using a brine solution, thus allowing for repeated use and minimizing waste.

The hot water outlet 122 allows water to be supplied to the establishment for hot water use, such as to a hot water heater to be used for cleaning dishes or other tasks. This reduces and may eliminate the need for any water to be discarded from the water purification and treatment system 100. For embodiments of the system 102 with a five-micron filter 124, the five-micron filter 124 is configured to filter out more contaminants than was previously filtered out. For example, the five-micron filter 124 may filter out silt, some types of mold, certain types of bacteria, dirt, sediment, and asbestos. Other filters with different micron ratings may also be implemented. The valve 126 may be positioned after the five-micron filter 124 and may be configured to shut down the system at a particular point. For example, the valve 126 can be used to stop water flow through the reverse osmosis feed pump 130 and the reverse osmosis membrane 136 without requiring that supply to the establishment’s hot water be cut off.

The reverse osmosis feed pump 130 is configured to pump water from the water inlet 101 to the reverse osmosis membrane 136. The reverse osmosis feed pump 130 may be a high-pressure pump and/or may be configured to supply high-pressured water at a constant pressure regardless of the starting pressure of the water delivered from the water source. The net effect is that the reverse osmosis feed pump 130 boosts the water pressure in a manner that overcomes the municipal water back pressure and becomes the driving force that pushes the water against the reverse osmosis membrane 136 of the reverse osmosis system 102. The increased water pressure created by the reverse osmosis feed pump 130 increases the efficiency of separating water molecules across the reverse osmosis membrane 136. In addition, the increased turbulence created by the reverse osmosis feed pump 130 increases water flow against the reverse osmosis membrane 136, thereby reducing scale build-up as well as bacterial growth on the membrane 136. Furthermore, increased water pressure created by the reverse osmosis feed pump 130 enables the return of concentrate water back through one or more water purification and/or treatment steps disclosed herein, including those comprising reactive media, filtration media and adsorption media.

A key aspect of the water purification and treatment system 100 is the ability to maintain normal membrane life of 24 to 48 months, made possible by the reduction of scale build-up discussed above. The ability to maintain membrane life is critical to the concept of environmentally green. Simply exchanging a shorter membrane life is counter-productive, increases overall system cost and would exchange eliminating water waste for increased energy usage and plastic (membrane) usage along with increased service calls and the burning of fossil fuels to provide that service. A true "green" technology maintains or extends current service intervals, uses less, and has an overall lower impact. All other techniques that reduce or eliminate water usage simply exchange water use for fossil fuel, plastic, expense and electricity increases.

As mentioned above, use of the reverse osmosis feed pump 130 enables production of high-pressured water at a constant pressure, irrespective of the starting pressure of the water delivered by the municipality. In some embodiments, the water purification and treatment system 100 comprises a reverse osmosis feed pump 130 that increases the water pressure by, e.g., at least 10 psi, at least 15 psi, at least 20 psi, at least 25 psi, at least 30 psi, at least 35 psi, at least 40 psi, at least 45 psi, at least 50 psi, at least 55 psi, at least 60 psi, at least 65 psi, at least 70 psi, or at least 75 psi. In some embodiments, the water purification and treatment system 100 comprises a reverse osmosis feed pump 130 that increases the water pressure in a range of, e.g., at most 10 psi, at most 15 psi, at most 20 psi, at most 25 psi, at most 30 psi, at most 35 psi, at most 40 psi, at most 45 psi, at most 50 psi, at most 55 psi, at most 60 psi, at most 65 psi, at most 70 psi, or at most 75 psi. In some embodiments, the water purification and treatment system 100 comprises a reverse osmosis feed pump 130 that increases the water pressure in a range of, e.g., about 10 psi to about 60 psi, about 15 psi to about 60 psi, about 20 psi to about 60 psi, about 25 psi to about 60 psi, about 30 psi to about 60 psi, about 35 psi to about 60 psi, about 40 psi to about 60 psi, about 45 psi to about 60 psi, about 50 psi to about 60 psi, about 10 psi to about 65 psi, about 15 psi to about 65 psi, about 20 psi to about 65 psi, about 25 psi to about 65 psi, about 30 psi to about 65 psi, about 35 psi to about 65 psi, about 40 psi to about 65 psi, about 45 psi to about 65 psi, about 50 psi to about 65 psi, about 10 psi to about 70 psi, about 15 psi to about 70 psi, about 20 psi to about 70 psi, about 25 psi to about 70 psi, about 30 psi to about 70 psi, about 35 psi to about 70 psi, about 40 psi to about 70 psi, about 45 psi to about 70 psi, about 50 psi to about 70 psi, about 10 psi to about 75 psi, about 15 psi to about 75 psi, about 20 psi to about 75 psi, about 25 psi to about 75 psi, about 30 psi to about 75 psi, about 35 psi to about 75 psi, about 40 psi to about 75 psi, about 45 psi to about 75 psi, or about 50 psi to about 75 psi.

In some embodiments, water leaving the reverse osmosis feed pump 130 has a higher pressure relative to water entering the reverse osmosis feed pump 130 by, e.g., at least 10 psi, at least 15 psi, at least 20 psi, at least 25 psi, at least 30 psi, at least 35 psi, at least 40 psi, at least 45 psi, at least 50 psi, at least 55 psi, at least 60 psi, at least 65 psi, at least 70 psi, or at least 75 psi. In some embodiments, water leaving the reverse osmosis feed pump 130 has a higher pressure relative to water entering the reverse osmosis feed pump 130 in a range of, e.g., about 10 psi to about 20 psi, about 10 psi to about 25 psi, about 10 psi to about 30 psi, about 10 psi to about 35 psi, about 10 psi to about 40 psi, about 10 psi to about 45 psi, about 10 psi to about 50 psi, about 15 psi to about 20 psi, about 15 psi to about 25 psi, about 15 psi to about 30 psi, about 15 psi to about 35 psi, about 15 psi to about 40 psi, about 15 psi to about 45 psi, about 15 psi to about 50 psi, about 20 psi to about 25 psi, about 20 psi to about 30 psi, about 20 psi to about 35 psi, about 20 psi to about 40 psi, about 20 psi to about 45 psi, about 20 psi to about 50 psi, about 30 psi to about 35 psi, about 30 psi to about 40 psi, about 30 psi to about 45 psi, about 30 psi to about 50 psi, about 30 psi to about 55 psi, about 30 psi to about 60 psi, about 40 psi to about 45 psi, about 40 psi to about 50 psi, about 40 psi to about 55 psi, about 40 psi to about 60 psi, about 40 psi to about 65 psi, about 40 psi to about 70 psi, about 45 psi to about 50 psi, about 45 psi to about 55 psi, about 45 psi to about 60 psi, about 45 psi to about 65 psi, or about 45 psi to about 70 psi.

The reverse osmosis membrane 136 may comprise one or more semi-permeable membranes. The reverse osmosis membrane 136 may be hollow fiber or spiral wound. Examples of suitable materials used to produce the reverse osmosis membrane 136 include cellulose tri-acetate (CTA), cellulose acetate (CA), polyamide and thin film composite (TFC). The membranes can also be considered standard pressure (high pressure) or low energy (low pressure). Examples of commercially available reverse osmosis membranes include spiral- wound TFC membranes (Filmtec, Midland Ml), such as, e.g., XLE-4021 (low energy) and TW30- 4021 (high energy) and MT1812P24 (Applied Membranes, Inc, Vista, CA).

The reverse osmosis membrane 136 thus allows some water to pass through while blocking some water from passing through. This separates the water supplied to the reverse osmosis membrane 136 into permeate water which passes through the reverse osmosis membrane 136 and concentrate water which does not pass through the reverse osmosis membrane 136. Thus, the reverse osmosis membrane 136 is configured to produce permeate water and concentrate water.

Reverse osmosis is an effective mechanism for removing many types of molecules and ions from water. In this process the total dissolved solids (TDS) present in the incoming water remain with the concentrate water. In operation, an applied pressure is used to overcome osmotic pressure that is driven by chemical potential which results in the passage of pure solvent (e.g., water) through the membrane 136 and the retention of solute (e.g., dissolved solids and colloid particles) on the pressurized side of the membrane 136. Permeate water refers to the purified water that passes through the semi-permeable membrane 136 while concentrate water refers to the water on the pressurized side of the membrane 136 containing the retained solutes. In some embodiments, the pressure of permeate water leaving the reverse osmosis system 102 is atmospheric pressure. In some embodiments, permeate water leaving the reverse osmosis system 102 is under pressure.

Permeate water typically has a substantially lower level of total dissolved solids (TDS) than either the incoming filtered water or the concentrate water. In some embodiments, permeate water has a TDS concentration of, e.g., less than 5 ppm, less than 10 ppm, less than 25 ppm, less than 50 ppm, less than 75 ppm, less than 100 ppm, less than 125 ppm, less than 150 ppm, less than 175 ppm, or less than 200 ppm. In other embodiments, permeate water has a TDS concentration in the range of, e.g., about 5 ppm to about 50 ppm, about 5 ppm to about 75 ppm, about 5 ppm to about 100 ppm, about 10 ppm to about 50 ppm, about 10 ppm to about 75 ppm, about 10 ppm to about 100 ppm, about 25 ppm to about 50 ppm, about 25 ppm to about 75 ppm, about 25 ppm to about 100 ppm, about 25 ppm to about 125 ppm, about 25 ppm to about 150 ppm, about 25 ppm to about 175 ppm, about 25 ppm to about 200 ppm, about 50 ppm to about 75 ppm, about 50 ppm to about 100 ppm, about 50 ppm to about 125 ppm, about 50 ppm to about 150 ppm, about 50 ppm to about 175 ppm, about 50 ppm to about 200 ppm, about 75 ppm to about 100 ppm, about 75 ppm to about 125 ppm, about 75 ppm to about 150 ppm, about 75 ppm to about 175 ppm, or about 75 ppm to about 200 ppm.

Concentrate water typically has a substantially higher level of TDS than either the incoming filtered water or the permeate water. In some embodiments, the concentrate water has a TDS concentration of, e.g., more than 400 ppm, more than 500 ppm, more than 600 ppm, more than 700 ppm, more than 800 ppm, more than 900 ppm, more than 1,000 ppm, more than 1,250 ppm, more than 1,500 ppm, more than 1,750 ppm, more than 2,000 ppm, more than 2,250 ppm, more than 2,500 ppm, more than 2,750 ppm, or more than 3,000 ppm.

In some embodiments, the concentrate water has a TDS concentration in the range of, e.g., about 400 ppm to about 600 ppm, about 400 ppm to about 800 ppm, about 400 ppm to about 1,000 ppm, about 400 ppm to about 1,500 ppm, about 400 ppm to about 2,000 ppm, about 400 ppm to about 2,500 ppm, about 400 ppm to about 3,000 ppm, about 500 ppm to about 600 ppm, about 500 ppm to about 800 ppm, about 500 ppm to about 1,000 ppm, about 500 ppm to about 1,500 ppm, about 500 ppm to about 2,000 ppm, about 500 ppm to about 2,500 ppm, about 500 ppm to about 3,000 ppm, about 600 ppm to about 800 ppm, about 600 ppm to about 1,000 ppm, about 600 ppm to about 1,500 ppm, about 600 ppm to about 2,000 ppm, about 600 ppm to about 2,500 ppm, about 600 ppm to about 3,000 ppm, about 700 ppm to about 800 ppm, about 700 ppm to about 1,000 ppm, about 700 ppm to about 1,500 ppm, about 700 ppm to about 2,000 ppm, about 700 ppm to about 2,500 ppm, about 700 ppm to about 3,000 ppm, about 800 ppm to about 1,000 ppm, about 800 ppm to about 1,500 ppm, about 800 ppm to about 2,000 ppm, about 800 ppm to about 2,500 ppm, about 800 ppm to about 3,000 ppm, about 1,000 ppm to about 1,250 ppm, about 1,000 ppm to about 1,500 ppm, about 1,000 ppm to about 2,000 ppm, about 1,000 ppm to about 2,500 ppm, about 1,000 ppm to about 3,000 ppm, about 1,500 ppm to about 2,000 ppm, about 1,500 ppm to about 2,500 ppm, about 1,500 ppm to about 3,000 ppm, about 2,000 ppm to about 2,500 ppm, or about 2,000 ppm to about 3,000 ppm.

In some embodiments, permeate water has a lower TDS concentration relative to concentrate water by, e.g., at least 200 ppm, at least 300 ppm, at least 400 ppm, at least 500 ppm, at least 600 ppm, at least 700 ppm, at least 800 ppm, at least 900 ppm, at least 1,000 ppm, at least 1,250 ppm, at least 1,500 ppm, at least 1,750 ppm, at least 2,000 ppm, at least 2,250 ppm, at least 2,500 ppm, at least 2,750 ppm, or at least 3,000 ppm. In some embodiments, the permeate water has a lower TDS concentration relative to the concentrate water in the range of, e.g., about 400 ppm to about 600 ppm, about 400 ppm to about 800 ppm, about 400 ppm to about 1,000 ppm, about 400 ppm to about 1,500 ppm, about 400 ppm to about 2,000 ppm, about 400 ppm to about 2,500 ppm, about 400 ppm to about 3,000 ppm, about 500 ppm to about 600 ppm, about 500 ppm to about 800 ppm, about 500 ppm to about 1,000 ppm, about 500 ppm to about 1,500 ppm, about 500 ppm to about 2,000 ppm, about 500 ppm to about 2,500 ppm, about 500 ppm to about 3,000 ppm, about 600 ppm to about 800 ppm, about 600 ppm to about 1,000 ppm, about 600 ppm to about 1,500 ppm, about 600 ppm to about 2,000 ppm, about 600 ppm to about 2,500 ppm, about 600 ppm to about 3,000 ppm, about 700 ppm to about 800 ppm, about 700 ppm to about 1,000 ppm, about 700 ppm to about 1,500 ppm, about 700 ppm to about 2,000 ppm, about 700 ppm to about 2,500 ppm, about 700 ppm to about 3,000 ppm, about 800 ppm to about 1,000 ppm, about 800 ppm to about 1,500 ppm, about 800 ppm to about 2,000 ppm, about 800 ppm to about 2,500 ppm, about 800 ppm to about 3,000 ppm, about 1,000 ppm to about 1,250 ppm, about 1,000 ppm to about 1,500 ppm, about 1,000 ppm to about 2,000 ppm, about 1,000 ppm to about 2,500 ppm, about 1,000 ppm to about 3,000 ppm, about 1,500 ppm to about 2,000 ppm, about 1,500 ppm to about 2,500 ppm, about 1,500 ppm to about 3,000 ppm, about 2,000 ppm to about 2,500 ppm, or about 2,000 ppm to about 3,000 ppm.

The recirculation pipe 138 may comprise a third pressure gauge 140, a valve 142, a TDS sensor 144 and/or a flow sensor 146. The primary purpose of the recirculation pipe 138 is to recirculate the concentrate water from the reverse osmosis membrane 136 back through the reverse osmosis system 102. This reduces waste by mixing the concentrate water with incoming water from the water source and then purifying this water for use either as hot water, or by introducing this water to the reverse osmosis membrane 136. Additionally, recirculation of the concentrate water enables the reverse osmosis feed pump 130 to operate at higher pressures, leading to the benefits of the increased water pressure mentioned above with respect to the reverse osmosis feed pump 130, including increased efficiency of separating water molecules across the reverse osmosis membrane 136, increased turbulence created by the reverse osmosis feed pump 130 that increases water flow against the reverse osmosis membrane 136, and reduced scale build-up and bacterial growth on the membrane 136.

As discussed above, the water purification and treatment system 100 comprises one or more purification and/or treatment steps. In some embodiments, water may be purified and/or treated using a process that reduces one or more dissolved solids present in the water and/or removes particulate material suspended in the water, and/or removes organic contaminants present in the water. Dissolved solids include, without limitation, minerals, metals, and salts present in the water. In aspects of these embodiments, the water purification and treatment system 100 comprises two or more, three or more, four or more, five or more, purification and/or treatment steps.

Reactive media may be incorporated into the water purification and treatment system 100. Reactive media catalyzes or facilitates a reaction that removes dissolved solids present in the water, such as, e.g., iron, manganese, chlorine, hydrogen sulfide, carbon dioxide, and calcium carbonate. Reactive media can be a true catalyst that does not get consumed by the chemical reaction or may be a sacrificial catalyst that get used up by the reaction. Reactive media is useful for preventing or reducing build-up of solids on a semi-permeable membrane, thereby eliminating scale formation. Non-limiting examples of reactive media include, BRIM® (Systematrix, USA, Buena Park, CA), Calcite (Systematrix, USA, Buena Park, CA), COROSEX® (Systematrix, USA, Buena Park, CA), Greensand (Systematrix, USA, Buena Park, CA), PYROLOX® (Systematrix, USA, Buena Park, CA), KDF® (Systematrix, USA, Buena Park, CA), SCALESTOP™, Copper Guard (Next Filtration, Boynton Beach, FL), and FILTERSORB SP3® (CWG/Watch Water, USA, Largo, FL). Although only one water purification and/or treatment step comprising a reactive media may be needed, more than one such step may be required depending on the concentration of dissolved solids present in the municipal water. In some embodiments, the reactive media is a saltless reactive media. Saltless reactive media comprise one or more resins that prevent precipitation of dissolved solids without the addition of any chemicals or mineral exchange. Non-limiting examples of saltless anti-scale media include FILTERSORB SP3® and SCALESTOP™ which can prevent precipitation of calcium and magnesium precipitation without the addition of any chemicals or mineral exchange.

Filtration media may also be incorporated into the water purification and treatment system 100. Filtration media removes suspended particulate matter like sand, silt, sediment, and/or dirt by trapping or filtering the matter away from the water. Filtration media may be a nanofiltration media, ultrafiltration media and microfiltration media. In aspects of these embodiments, two or more, three or more, four or more, of five or more, filtration media may be used to purify and/or treat water. In aspects of these embodiments, a filtration media may comprise graded layers of gravel and sand. In other aspects of these embodiments, filtration media may comprise graded layers of gravel, sand and anthracite coal. In yet other aspects of these embodiments, filtration media may comprise graded layers of gravel, garnet, and sand. In still other aspects of these embodiments, filtration media may comprise graded layers of gravel, garnet, sand and anthracite coal. Non-limiting examples of filtration media include anthracite coal (Systematrix, USA, Buena Park, CA), FILTER-AG® (Systematrix, USA, Buena Park, CA), garnet, gravel, NEXTSAND™ (Systematrix, USA, Buena Park, CA), and sand. Although only one water purification and/or treatment step comprising a filtration media may be needed, more than one such step may be required depending on the types and amount of suspended particulate matter present in the municipal water.

In some embodiments, filtration media can remove suspended solids that are, e.g., at least 5 μm, at least 10 μm, at least 15 μm, at least 20 μm, at least 30 μm, at least 40 μm, at least 50 μm, at least 60 μm, at least 70 μm, at least 80 μm, at least 90 μm, or at least 100 μm in average diameter. In some embodiments, filtration media can remove suspended solids that are, e.g., at most 5 μm, at most 10 μm, at most 15 μm, at most 20 μm, at most 30 μm, at most 40 μm, at most 50 μm, at most 60 μm, at most 70 μm, at most 80 μm, at most 90 μm, or at most 100 μm in average diameter. In some embodiments, filtration media can remove suspended solids that are in the range of, e.g., about 5 μm to about 10 μm, about 5 μm to about 20 μm, about 5 μm to about 30 μm, about 5 μm to about 40 μm, about 5 μm to about 60 μm, about 5 μm to about 80 μm, about 5 μm to about 100 μm, about 10 μm to about 20 μm, about 10 μm to about 30 μm, about 10 μm to about 40 μm, about 10 μm to about 60 μm, about 10 μm to about 80 μm, about 10 μm to about 100 μm, about 20 μm to about 40 μm, about 20 μm to about 60 μm, about 20 μm to about 80 μm, about 20 μm to about 100 μm, about 40 μm to about 60 μm, about 40 μm to about 80 μm, about 40 μm to about 100 μm, about 60 μm to about 80 μm, about 60 μm to about 100 μm, or about 80 μm to about 100 μm.

Adsorptive media may also be incorporated into the water purification and treatment system 100. Adsorptive media adsorbs dissolved solids and organic contaminants like arsenic, chlorine, and fluoride which can cause unpleasant odors, tastes, color, and/or turbidity in the water. Non- limiting examples of adsorptive media include, activated carbon (Systematrix, USA, Buena Park, CA), activated alumina (Systematrix, USA, Buena Park, CA), ARSENXNP™ (Systematrix, USA, Buena Park, CA), and BONE CHAR™ (Systematrix, USA, Buena Park, CA). Although only one water purification and/or treatment step comprising an adsorptive media may be needed, more than one such step may be required depending on the concentration of dissolved solids and organic contaminants present in the municipal water.

As mentioned above, in some embodiments, the water purification and treatment system 100 is configured to return the concentrate water back through one or more water purification and/or treatment steps disclosed herein, including those comprising reactive media, filtration media and adsorption media. This may be done with the recirculation pipe 138. This design avoids the need to dispose of any concentrate water into a municipal sewer line, avoids the need to store concentrate water for eventual use in application not requiring potable water; and avoids the need to use a high-energy electrical pump to push the concentrate water back into the plumbing lines. As such, some embodiments of the water purification and treatment system 100 disclosed herein do not dispose of or store concentrate water, but instead return the concentrate water back through one or more water purification and/or treatment steps disclosed herein.

In some embodiments, substantially all the concentrate water is returned back through one or more water purification and/or treatment steps disclosed herein. In some embodiments, the amount of concentrate water returned back through one or more water purification and/or treatment steps disclosed herein may be 100%. In some embodiments, the amount of concentrate water returned back though one or more water purification and/or treatment steps disclosed herein may be, e.g., at least 70%, at least 75%, at least 80%, at least 85%, at least 86%, at least 87%, at least 88%, at least 89%, at least 90%, at least 91 %, at least 92%, at least 93%, at least 94%, at least 95%, at least 96%, at least 97%, at least 98%, at least 99%. In some embodiments, the amount of concentrate water returned back though one or more water purification and/or treatment steps disclosed herein is in the range of, e.g., about 70% to about 100%, about 75% to about 100%, about 80% to about 100%, about 85% to about 100%, about 86% to about 100%, about 87% to about 100%, about 88% to about 100%, about 89% to about 100%, about 90% to about 100%, about 91 % to about 100%, about 92% to about 100%, about 93% to about 100%, about 94% to about 100%, about 95% to about 100%, about 96% to about 100%, about 97% to about 100%, about 98% to about 100%.

In some embodiments, the water purification and treatment system 100 has a minimal water to waste ratio of 1:0. This means that for every gallon of permeate water produced, no concentrate (or unpurified) water is disposed into a municipal sewer line, stored for a subsequent use, or otherwise not returned to the water purification and treatment system 100 for additional processing. In some embodiments, the water purification and treatment system 100 has a minimal water to waste ratio of, e.g., no more than 1:0.1, no more than 1:0.2, no more than 1:0.3, no more than 1:0.4, no more than 1:0.5, no more than 1:0.6, no more than 1:0.7, no more than 1:0.8, or no more than 1:0.9. In other embodiments, the water purification and treatment system 100 has a minimal water to waste ratio in the range of, e.g., about 1:0 to about 1:0.1, about 1:0 to about 1:0.2, about 1:0 to about 1:0.3, about 1:0 to about 1:0.4, about 1:0 to about 1:0.5, about 1:0 to about 1:0.6, about 1:0 to about 1:0.7, about 1:0 to about 1:0.8, about 1:0 to about 1:0.9, about 1:0.1 to about 1:0.2, about 1:0.1 to about 1:0.3, about 1:0.1 to about 1:0.4, about 1:0.1 to about 1:0.5, about 1:0.1 to about 1:0.6, about 1:0.1 to about 1:0.7, about 1:0.1 to about 1:0.8, about 1:0.1 to about 1:0.9, about 1:0.2 to about 1:0.3, about 1:0.2 to about 1:0.4, about 1:0.2 to about 1:0.5, about 1:0.2 to about 1:0.6, about 1:0.2 to about 1:0.7, about 1:0.2 to about 1:0.8, or about 1:0.2 to about 1:0.9.

In some embodiments, the water purification and treatment system 100 further comprises flow restrictors in order to increase water pressure. A non-limiting example of a flow restrictor is described in U.S. Patent 7,285,210, which is hereby incorporated by reference in its entirety. In some embodiments, the water purification and treatment system 100 does not comprise flow restrictors in order to increase water pressure.

In some embodiments, the water purification and treatment system 100 comprises solenoid valves. Solenoid valves regulate the volume of water flowing into the reverse osmosis system 102. When an insufficient volume of water is present, the solenoid valve can be opened to allow water to flow into the reverse osmosis system 102. When an excessive volume of water is present, the solenoid valve can be closed to prevent water from flowing into the reverse osmosis system 102. Operation of a solenoid valve can be accomplished using a pressure switch or a float device. In some embodiments, solenoid valves may cause undesired water hammer. For this reason, ball valves may be preferred over solenoid valves. However, both types of valves are considered to be part of this disclosure.

The water formulation system 104 may comprise one or more TDS sensors 144, a calcite filter 148, a storage tank 150, a first water formulation supply 152, a second water formulation supply 154, a level sensor 156, a vent 158, a mixer pump 160, a static inline mixer 162, a delivery pump 164, one or more valves 166 and/or a flow sensor 168. The water formulation system 104 is fluidly coupled to the reverse osmosis system 102 and is configured to receive the permeate water from the reverse osmosis system 102. A TDS sensor 144 may be positioned first in the water formulation system 104. This measures TDS levels in the permeate water directly after the reverse osmosis membrane 136, and thus provides information on how well the reverse osmosis membrane 136 is functioning. The calcite filter 148 may be fluidly coupled between the reverse osmosis system 102 and the storage tank 150 and is configured to neutralize the permeate water before the permeate water enters the storage tank 150. The storage tank 150 may be formed of stainless steel to limit the contamination of the permeate water by the storage tank 150 itself, such as with forever chemicals or micro-plastics. Neutralizing the permeate water before the permeate water enters the storage tank 150 may thus be an important step to decreasing corrosion of the storage tank 150 by the permeate water.

The permeate water enters the storage tank 150 and is stored there until needed. Permeate water may also be referred to in this disclosure as purified water. In some embodiments, the pressure of permeate water stored in the storage tank 150 is atmospheric pressure. In some embodiments, the permeate water stored in the storage tank 150 is under pressure. The storage tank 150 may have a vent 158 configured to allow air to enter and exit the storage tank 150. The vent 158 may be configured to block contaminants from entering the storage tank 150. In some embodiments, the vent 158 has a micron rating.

The level of stored purified water in the storage tank 150 may be monitored by the level sensor 156. The level sensor 156 may be a pressure sensor, a float sensor, or an ultrasonic level sensor. The level sensor 156 may work with a controller to monitor the level of water in the storage tank 150. When the level of water in the storage tank 150 is lower than a refill threshold level, such as less than 75% full, the reverse osmosis feed pump 130 may be automatically turned on to refill the storage tank 150. Similarly, when the level of water in the storage tank 150 is higher than a full threshold level, the reverse osmosis feed pump 130 may be automatically turned off to stop production of permeate water through the reverse osmosis membrane 136.

In some situations, a component of the reverse osmosis system 102 or the water formulation system 104 may fail, causing these systems to not work properly. In such situations, the reverse osmosis feed pump 130 may not turn on, even when the level of water in the storage tank 150 lowers past the refill threshold level. Thus, when the level of water in the storage tank is lower than an empty threshold level, the level sensor 156 and the controller may automatically open the bypass valve 108 to couple to the water inlet 101 directly to the water outlet 105. This is especially useful because access to water within the establishment is never cut off, even when the water purification and treatment system 100 is out of order or otherwise requires maintenance. As long as there is enough purified water in the storage tank 150, the purified water is used. Once the purified water lowers past the empty threshold level, the bypass valve 108 is automatically opened so that water continues to be accessible within the establishment for use by the user. The empty threshold level may be less than the refill threshold level.

The water formulation supplies 152, 154 may provide a mechanism to reformulate purified water by adding additives, such as, e.g., naturally occurring minerals, food-grade and self-certified compounds, and generally regarded as safe (GRAS) compounds. Water processed by reverse osmosis not only removes harmful contaminants but also depletes many of the good, healthy minerals originally present in the water. These beneficial minerals add to the taste of the water as well as the flavor of beverages brewed with water. Reformulation of the water with additives using a reformulation system disclosed herein adds back beneficial minerals in a controlled manner that ensures better quality control of the mineral content water being used at an establishment. In addition, reformulation of water to various TDS levels may be used to simulate water from other areas to demonstrate flavor variability caused by minerals. Non-limiting examples of beneficial minerals include potassium bicarbonate, sodium bicarbonate, and calcium chloride. Thus, each of the first water formulation supply 152 and the second water formulation supply 154 may be configured to supply a first or second formulate to the storage tank 150 to treat the water. The first water formulation supply 152 has a first formulation inlet 174 and the second water formulation supply 154 has a second formulation inlet 176.

Each of the water reformulation supplies 152, 154 comprises one or more additive tanks 170 that contain the appropriate additives and a peristaltic pump 172. The storage tank 150 may have a TDS sensor 144 that is positioned to measure TDS levels in the water in the storage tank 150. This information can then be evaluated to determine whether the purified water requires reformulation to achieve a desired formulation of the water in the storage tank 150. In some embodiments, there is only one water formulation supply 152. In embodiments with more than one water formulation supply 152, 154, the first water formulation supply 152 and the second water formulation supply 154 may contain different additives that affect the formulation of the water in different ways. Thus, the first water formulation supply 152 and the second water formulation supply 154 can be controlled to release additives to a predetermined level based on the concentration of minerals desired. The peristaltic pump 172 can be used to pump additives into the purified water. Additives may also be added using a water piston driven pump such as a dosatron style water driven pump.

In some embodiments, the additives found in the first water formulation supply 152 may be such that combination with the additives found in the second water formulation supply 154 would result in the additives reacting with each other and precipitating out of the purified water. In such embodiments, the first formulation inlet 174 may be positioned on an opposite side of the storage tank 150 from the second formulation inlet 176. This allows the additives in the first formulate to properly mix with the water and become diluted enough before contacting the additives in the second formulate that no precipitate is formed. In such a design, the additives are diluted to a sufficient amount to prevent precipitation of the additives. In some embodiments, the water formulation system 104 comprises, e.g., at least two additive tanks, at least three additive tanks, at least four additive tanks, or at least five additive tanks, each designed to separately deliver the additives directly to the purified water in the storage tank 150. In some embodiments, the water formulation system 104 comprises, e.g., two additive tanks, three additive tanks, four additive tanks, or five additive tanks, each designed to separately deliver the additives directly to the purified water in the storage tank 150. In some embodiments, the water formulation system 104 comprises between, e.g., two to three additive tanks, two to four additive tanks, two to five additive tanks, three to four additive tanks, three to five additive tanks, or four to five additive tanks, each designed to separately deliver the additives directly to the purified water in the storage tank 150.

In some embodiments, the water formulation system 104 adjusts the beneficial mineral to a desired mineral concentration. In some embodiments, the water formulation system 104 adjusts the beneficial mineral concentration to, e.g., about 50 ppm, about 75 ppm, about 100 ppm, about 125 ppm, about 150 ppm, about 175 ppm, about 200 ppm, about 300 ppm, about 400 ppm, about 500 ppm, about 600 ppm, about 700 ppm, about 800 ppm, about 900 ppm, about 1,000 ppm, about 1,100 ppm, about 1,200 ppm, about 1,300 ppm, about 1,400 ppm, or about 1,500 ppm. In some embodiments, the water formulation system 104 adjusts the beneficial mineral concentration in a range of, e.g., about 50 ppm to 150 ppm, about 50 ppm to 200 ppm, about 50 ppm to 300 ppm, about 50 ppm to 400 ppm, about 50 ppm to 500 ppm, about 75 ppm to 150 ppm, about 75 ppm to 200 ppm, about 75 ppm to 300 ppm, about 75 ppm to 400 ppm, about 75 ppm to 500 ppm, about 100 ppm to 150 ppm, about 100 ppm to 200 ppm, about 100 ppm to 300 ppm, about 100 ppm to 400 ppm, about 100 ppm to 500 ppm, about 125 ppm to 150 ppm, about 125 ppm to 200 ppm, about 125 ppm to 300 ppm, about 125 ppm to 400 ppm, or about 125 ppm to 500 ppm. In some embodiments, the water formulation system 104 adjusts the beneficial mineral concentration in a range of, e.g., about 100 ppm to 500 ppm, about 100 ppm to 750 ppm, about 100 ppm to 1,000 ppm, about 100 ppm to 1,250 ppm, about 100 ppm to 1,500 ppm, about 100 ppm to 1,750 ppm, about 100 ppm to 2,000 ppm, about 200 ppm to 500 ppm, about 200 ppm to 750 ppm, about 200 ppm to 1,000 ppm, about 200 ppm to 1,250 ppm, about 200 ppm to 1,500 ppm, about 200 ppm to 1,750 ppm, about 200 ppm to 2,000 ppm, about 250 ppm to 500 ppm, about 250 ppm to 750 ppm, about 250 ppm to 1,000 ppm, about 250 ppm to 1,250 ppm, about 250 ppm to 1,500 ppm, about 250 ppm to 1,750 ppm, about 250 ppm to 2,000 ppm, about 500 ppm to 750 ppm, about 500 ppm to 1,000 ppm, about 500 ppm to 1,250 ppm, about 500 ppm to 1,500 ppm, about 500 ppm to 1,750 ppm, or about 500 ppm to 2,000 ppm.

The desired formulation of water in the storage tank 150 may be adjustable by the user. In some embodiments, the desired formulation is adjustable remotely. In some embodiments, the desired formulation is adjustable on-site. In some embodiments, the desired formulation is adjustable both remotely and on-site. The adjustability of the desired formulation is important because the user can select the formulation of the water based on how the water will be used. Thus, different “recipes” for water formulation may be implemented depending on whether the user will be making light roast coffee, medium roast, or dark roast. The user may have access to a toggle switch to select between these options. Thus, the user has full control over the formulation of the water and can adjust the desired formulation as needed. As an example, for light roast coffee, the desired formulation of water may be 101 ppm to 125 ppm. For medium roast coffee, the desired formulation of water may be 125 ppm to 135 ppm. For dark roast coffee, the desired formulation of water may be 135 ppm to 150 ppm. For herbal tea, the desired formulation of water may be 101 ppm to 125 ppm. For oolong tea, the desired formulation of water may be 115 ppm to 125 ppm. For black tea, the desired formulation of water may be 135 ppm to 150 ppm.

The mixer pump 160 and the static inline mixer 162 are configured to maintain movement of the water within the storage tank 150 and move the purified water in a controlled manner in order to facilitate proper mixing of additives added to the water. The mixer pump 160 is positioned to draw water from the storage tank 150 and is configured to pump this water through the static inline mixer 162 to mix the water and pump it back into the storage tank 150. This helps to maintain the uniformity of the composition of the water within the storage tank 150, helps to ensure that accurate measurements are taken by the TDS sensor 144, and helps to prevent precipitation of minerals out of the water. As shown in FIG. 1, one or more valves 166 may control whether water is being drawn from the storage tank 150 into the mixer pump 160 and the static inline mixer 162. The mixer pump 160 may be a magnetic pump.

Upon demand for purified water, the delivery pump 164 turns on and the corresponding valve 166 is opened, which pumps stored purified water through the bypass valve 108 and the water outlet 105. The delivery pump 164 may increase the pressure of the purified water to between about 45 psi and about 60 psi. As discussed above, the SRE filter 112 may filter the purified, treated water to remove unwanted taste and/or odors. Filtered water may then flow through the water outlet 105 to point-of-use sites of establishment requiring purified water. As noted above, the bypass valve 108 may be a three-way valve. This valve 108 allows for system service or emergency usage in case of equipment shut down and redirects the water to the water outlet 105.

The water purification and treatment system 100 may also comprise a drain 178 configured to drain water from the storage tank 150. This may be used in cases where the storage tank 150 needs to be quickly emptied. A corresponding valve 166 may be implemented to allow control over when the drain 178 is open.

As noted above, the water purification and treatment system 100 may also comprise a controller, such as a program logic controller (PLC), that is operably coupled to components such as the pressure sensors 103, 120, 128, 132, the valves 106, 108, 126, 142, 166, the reverse osmosis feed pump 130, the TDS sensors 144, the flow sensors 146, 168, the level sensor 156, the vent 158, the first formulation supply 152, the second formulation supply 154, the mixer pump 160, and/or the delivery pump 164. This allows the system to largely function in an automatic mode, where the controller monitors the system and makes changes to keep the storage tank 150 full of purified water that has been treated to the desired formulation of water, and where the controller also automatically moves the system 100 into bypass mode as needed. This allows the establishment to maintain a constant supply of water. The controller may be communicatively coupled to the internet to allow the water purification and treatment system 100 to be controllable remotely. The controller may also be configured to automatically notify a service provider when maintenance or service is required. This removes the need for personnel within the establishment to have any interaction with the water purification and treatment system 100.

As noted above, the controller may be configured to automatically prompt the service provider for service when required. This may be due to scheduled maintenance or due to a failing component of the water purification and treatment system 100. This eliminates unnecessary service calls. In some embodiments, the water purification and treatment system 100 is configured with extended operational life with designated six-month service intervals. Other intervals may also be implemented. By reducing the frequency that the water purification and treatment system 100 requires service, the water purification and treatment system 100 also reduces traffic and fuel consumption because service providers do not need to spend as much time on the road travelling to service the water purification and treatment system 100. In some embodiments, the water purification and treatment system 100 has built-in self-diagnostics and is thus configured to provide self-diagnostics to the water purification and treatment system 100 to allow the controller to identify which components require service and/or what type of service is needed.

The controller may also be configured to provide information regarding the operation of the system 100 to the service provider, to the user, or to another party. The controller may be configured to provide this information on-site, such as to a computer screen located on the water purification and treatment system 100 or in another location on-site. In some embodiments, the controller is configured to provide this information to a remote location, such as to the service provider. The controller may provide information regarding how each component is operating. The controller may also provide alerts when a component is no longer functioning.

In some embodiments, the controller is also configured to provide information regarding the water purification and treatment system 100 to the public. This is particularly helpful in providing information such as water savings or energy savings to the public so that the public is aware of the benefits being provided by the water purification and treatment system 100. For example, the controller may be configured to estimate an amount of water that has been saved by the store through the use of the water purification and treatment system 100. This water savings estimate may be based on normal operating parameters for reverse osmosis systems. Both single user savings (such as just one store location) and company-wide water savings may be tracked and reported. The controller may be configured to automatically share this water savings over the internet so that customers at a particular store can see how many gallons of water a particular store has saved or what the company-wide water savings are. In some embodiments, the water purification and treatment system 100 has an LED screen which is customer-oriented, allowing the customer to view water usage and water savings. The LED screen may be an interactive system, allowing the user to select which information to display. The water savings and other information may also be shared over the internet, making it available on mobile devices. In some embodiments, a mobile app may be available to display information gathered by the controller, such as water savings, fuel savings, etc. The controller may use an algorithm to estimate water savings, as mentioned above.

In some embodiments, the controller is configured to estimate water softener savings by the user. Water softeners contain salt, which prevents municipalities from recycling wastewater containing water softeners as irrigation water. The presently disclosed water purification and treatment system 100 allows municipalities to use the wastewater for other uses, such as for irrigation. Thus, the controller may help provide information regarding the water savings and salt savings associated with using the water purification and treatment system 100.

The water purification and treatment system 100 may also comprise one or more check valves 180 throughout the system 100. The check valves 180 are configured to restrict fluid flow in one direction so that water does not travel the wrong direction through the system 100. For example, as shown in FIG. 1, there may be a check valve 180 positioned on the hot water outlet 122, in the recirculation pipe 138, and/or in the delivery pipe 182 connected to the water outlet 105 through the bypass valve 108.

The embodiment described in FIG. 1 is provided for illustrative purposes only in order to facilitate a more complete understanding of the water purification and treatment system 100 disclosed herein. This embodiment should not be construed to limit any of the other embodiments described in the present specification. Those skilled in the art to which this disclosure pertains will readily appreciate that numerous changes, variations, and modifications can be made to the embodiment depicted in FIG. 1 based on the full disclosure of the present specification.

In some embodiments, the water purification and treatment system 100 is manufactured as one complete unit that can be shipped and installed without requiring assembly of the water purification and treatment system 100. This is beneficial because there is no need for a complicated installation with multiple components that must be connected correctly. Instead, the unit can be positioned where desired, connected to a water source and a water outlet, and is ready to use as is. This reduces installation costs and space required for housing the water purification and treatment system 100. In some embodiments, the water purification and treatment system 100 is configured to be manufactured and/or shipped as a single, compact, and ready-to-install unit.

The present specification is also related to a method of purifying and/or treating water. In some embodiments, the method of purifying and/or treating water comprises using the water purification and treatment system 100 disclosed herein. Typically, a water source like municipal water, is diverted to the water purification and treatment system 100 before reaching point-of-use sites. In some embodiments, a water source is diverted to a reverse osmosis system 102 that filters the water and then pumps the water through a reverse osmosis membrane 136 that produces permeate water and concentrate water. The concentrate water may be recirculated through the reverse osmosis system 102.The permeate water may be diverted to a storage tank 150, where the permeate water may additionally be formulated.

The present specification relates to a method of reformulating water. In some embodiments, a TDS sensor 144 detects the total dissolved solids of a water source and a controller evaluates the data in order to determine whether adjustment or reformulation of the water source is required. Evaluation may be based on a pre-determined criteria based on industry standards or set by a user employing the reformulation method, such as, e.g., concentration of total dissolved solids, concentration of total minerals, concentration of specific dissolved solids, or concentration of specific minerals. If the evaluation determines that reformulation is necessary, the controller sends a signal that turns on a peristaltic pump 172 corresponding with a first water formulation supply 152 or a second water formulation supply 154. The peristaltic pump 172 is configured to separately draw up additives contained in one or more additive tanks and release the additives into the water source. The released additives are then mixed with the water source using, e.g., a static inline mixer 162.

The present disclosure is also related to a method for supplying formulated water to an establishment using a water purification and treatment system 100. The method may comprise any of the following steps: providing water from a water source; passing the water through a reverse osmosis system 102 of the water purification and treatment system 100 to produce permeate water and concentrate water; recirculating the concentrate water through the reverse osmosis system 102; passing the permeate water to a storage tank 150 of the water purification and treatment system 100; filling the storage tank 150 with the permeate water to a full threshold level; monitoring a level of water in the storage tank 150; automatically refilling the storage tank 150 to the full threshold level when the level of water in the storage tank 150 lowers past a refill threshold level; treating the water in the storage tank 150 to have a desired formulation; delivering the formulated water to the establishment; automatically notifying a service company of a need for service when the level of water in the storage tank 150 lowers past the refill threshold level and the water purification and treatment system 100 fails to refill the storage tank 150; and automatically bypassing the reverse osmosis system 102 and the storage tank 150 when the level of water in the storage tank 150 lowers past an empty threshold level. The method may also comprise neutralizing the permeate water before passing the permeate water to the storage tank 150.

It will be understood that implementations of a water purification and treatment system are not limited to the specific assemblies, devices and components disclosed in this document, as virtually any assemblies, devices and components consistent with the intended operation of a water purification and treatment system may be used. Accordingly, for example, although particular water purification and treatment systems, and other assemblies, devices and components are disclosed, such may include any shape, size, style, type, model, version, class, measurement, concentration, material, weight, quantity, and/or the like consistent with the intended operation of water purification and treatment systems. Implementations are not limited to uses of any specific assemblies, devices and components; provided that the assemblies, devices and components selected are consistent with the intended operation of a water purification and treatment system.

Accordingly, the components defining any water purification and treatment system may be formed of any of many different types of materials or combinations thereof that can readily be formed into shaped objects provided that the materials selected are consistent with the intended operation of a water purification and treatment system. For example, the components may be formed of: polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; glasses (such as quartz glass), carbon-fiber, aramid-fiber, any combination thereof, and/or other like materials; composites and/or other like materials; metals, such as zinc, magnesium, titanium, copper, lead, iron, steel, carbon steel, alloy steel, tool steel, stainless steel, brass, nickel, tin, antimony, pure aluminum, 1100 aluminum, aluminum alloy, any combination thereof, and/or other like materials; alloys, such as aluminum alloy, titanium alloy, magnesium alloy, copper alloy, any combination thereof, and/or other like materials; any other suitable material; and/or any combination of the foregoing thereof. In instances where a part, component, feature, or element is governed by a standard, rule, code, or other requirement, the part may be made in accordance with, and to comply under such standard, rule, code, or other requirement.

Various water purification and treatment systems may be manufactured using conventional procedures as added to and improved upon through the procedures described here. Some components defining a water purification and treatment system may be manufactured simultaneously and integrally joined with one another, while other components may be purchased pre-manufactured or manufactured separately and then assembled with the integral components. Various implementations may be manufactured using conventional procedures as added to and improved upon through the procedures described here.

Accordingly, manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components.

It will be understood that methods for manufacturing or assembling water purification and treatment systems are not limited to the specific order of steps as disclosed in this document. Any steps or sequence of steps of the assembly of a water purification and treatment system indicated herein are given as examples of possible steps or sequence of steps and not as limitations, since various assembly processes and sequences of steps may be used to assemble water purification and treatment systems.

The implementations of a water purification and treatment system described are by way of example or explanation and not by way of limitation. Rather, any description relating to the foregoing is for the exemplary purposes of this disclosure, and implementations may also be used with similar results for a variety of other applications employing a water purification and treatment system.

What is claimed is:

1. A water purification and treatment system, comprising:
a water inlet configured to receive water from a water source;
a reverse osmosis system fluidly coupled to the water inlet and configured to purify the water passing through the reverse osmosis system, the reverse osmosis system having:
a reverse osmosis membrane configured to produce permeate water which passes through the reverse osmosis membrane and concentrate water which recirculates back through the reverse osmosis system;
a reverse osmosis feed pump configured to pump water from the water inlet to the reverse osmosis membrane; and
a recirculation pipe configured to pass the concentrate water from the reverse osmosis membrane back through the reverse osmosis system;
a water formulation system fluidly coupled to the reverse osmosis system and configured to receive the permeate water from the reverse osmosis system, the water formulation system having:
a storage tank configured to store the permeate water, the storage tank comprising a level sensor configured to measure a level of water within the storage tank;
a static inline mixer configured to maintain movement of the water within the storage tank;
a first water formulation supply configured to supply a first formulate to the storage tank to treat the water, the first water formulation supply having a first formulation inlet into the storage tank; and
a second water formulation supply configured to supply a second formulate to the storage tank to treat the water, the second water formulation supply having a second formulation inlet into the storage tank positioned on an opposite side of the storage tank from the first formulation inlet;
a water outlet fluidly coupled to the water formulation system and configured to supply water to a user;
a bypass having a bypass valve configured to selectively couple the water inlet directly to the water outlet; and
a controller operably coupled to the reverse osmosis feed pump, the level sensor, the first water formulation supply, the second water formulation supply, and the bypass valve, wherein the controller is configured to:
monitor the level of water within the storage tank through the level sensor;
turn on the reverse osmosis feed pump when the level of water in the storage tank is lower than a refill threshold level;
turn off the reverse osmosis feed pump when the level of water in the storage tank is higher than a full threshold level;
automatically open the bypass valve to couple the water inlet directly to the water outlet when the level of water in the storage tank is lower than an empty threshold level; and
control the first water formulation supply and the second water formulation supply to achieve a desired formulation of water in the storage tank.

2. The water purification and treatment system of claim 1, wherein the desired formulation of water in the storage tank is adjustable by the user.

3. The water purification and treatment system of claim 1, wherein the level sensor is an ultrasonic level sensor.

4. The water purification and treatment system of claim 1, wherein the reverse osmosis system has a filter with an anion resin configured to reduce a level of forever chemicals present in the water.

5. The water purification and treatment system of claim 1, wherein the water purification and treatment system is configured to be shipped as a single ready-to-install unit.

6. The water purification and treatment system of claim 1, wherein the controller is configured to provide self-diagnostics to the water purification and treatment system.

7. The water purification and treatment system of claim 6, wherein the controller is configured automatically notify a service provider when maintenance or service of the water purification and treatment system is required.

8. A water purification and treatment system, comprising:
a water inlet configured to receive water from a water source;
a reverse osmosis system fluidly coupled to the water inlet and configured to purify water passing through the reverse osmosis system;
a water formulation system fluidly coupled to the reverse osmosis system and configured to receive permeate water from the reverse osmosis system, the water formulation system having:
a storage tank configured to store the permeate water, the storage tank comprising a level sensor configured to measure a level of water within the storage tank; and
a first water formulation supply configured to supply a first formulate to the storage tank to treat the water, the first water formulation supply having a first formulation inlet into the storage tank;
a water outlet fluidly coupled to the water formulation system and configured to supply water to a user;
a bypass having a bypass valve configured to selectively couple the water inlet directly to the water outlet; and
a controller operably coupled to the reverse osmosis system, the level sensor, the first water formulation supply, and the bypass valve, wherein the controller is configured to:
turn on the reverse osmosis system when the level of water in the storage tank is lower than a refill threshold level;
turn off the reverse osmosis system when the level of water in the storage tank is higher than a full threshold level;
automatically open the bypass valve to couple the water inlet directly to the water outlet when the level of water in the storage tank is lower than an empty threshold level; and
control the first water formulation supply to achieve a desired formulation of water in the storage tank.

9. The water purification and treatment system of claim 8, the reverse osmosis system having a recirculation pipe configured to pass concentrate water produced by the reverse osmosis system back through the reverse osmosis system.

10. The water purification and treatment system of claim 8, the water formulation system further having a static inline mixer configured to maintain movement of the water within the storage tank.

11. The water purification and treatment system of claim 8, the water formulation system further having a second water formulation supply configured to supply a second formulate to the storage tank to treat the water, the second water formulation supply having a second formulation inlet into the storage tank positioned on an opposite side of the storage tank from the first formulation inlet.

12. The water purification and treatment system of claim 8, wherein the reverse osmosis system has a filter with an anion resin configured to reduce a level of forever chemicals present in the water.

13. The water purification and treatment system of claim 8, wherein the water purification and treatment system is configured to be shipped as a single ready-to-install unit.

14. The water purification and treatment system of claim 8, wherein the level sensor is an ultrasonic level sensor.

15. A water purification and treatment system, comprising:
a water inlet configured to receive water from a water source;
a water formulation system fluidly coupled to a reverse osmosis system and configured to receive permeate water from the water inlet through the reverse osmosis system, the water formulation system having a storage tank configured to store the permeate water;
a water outlet fluidly coupled to the water formulation system and configured to supply water to a user;
a bypass having a bypass valve configured to selectively couple the water inlet directly to the water outlet; and
a controller operably coupled to the bypass valve, wherein the controller is configured to automatically open the bypass valve to couple the water inlet directly to the water outlet when a level of water in the storage tank is lower than an empty threshold level.

16. The water purification and treatment system of claim 15, the storage tank comprising an ultrasonic level sensor configured to measure a level of water within the storage tank.

17. The water purification and treatment system of claim 15, the water formulation system further having a static inline mixer configured to maintain movement of the water within the storage tank.

18. The water purification and treatment system of claim 15, the water formulation system further having a first water formulation supply configured to supply a first formulate to the storage tank to treat the water, the first water formulation supply having a first formulation inlet into the storage tank, wherein the controller is operably coupled to the first water formulation supply and is configured to control the first water formulation supply to achieve a desired formulation of water in the storage tank.

19. The water purification and treatment system of claim 18, the water formulation system further having a second water formulation supply configured to supply a second formulate to the storage tank to treat the water, the second water formulation supply having a second formulation inlet into the storage tank positioned on an opposite side of the storage tank from the first formulation inlet.

20. The water purification and treatment system of claim 18, wherein the desired formulation of water in the storage tank is adjustable by the user.

21. The water purification and treatment system of claim 15, wherein the reverse osmosis system has a filter with an anion resin configured to reduce a level of forever chemicals present in the water.

22. The water purification and treatment system of claim 15, wherein the water purification and treatment system is configured to be shipped as a single ready-to-install unit.
